(19) United States
(12) Patent Application Publication
(10) Pub. No.: US 2006/0070298 A1
(43) Pub. Date: Apr. 6, 2006

(54) Planter with folding legs

(76) Inventor: Jeffrey J. Palsrok, Zeeland, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/243,343

(22) Filed: Oct. 4, 2005

Related U.S. Application Data
(60) Provisional application No. 60/616,479, filed on Oct. 6, 2004.

(51) Int. Cl. A01G 9/02

(52) U.S. Cl. 47/66.3

(57) ABSTRACT

A plant stand includes a plant holder box having side walls, end walls, and a bottom that combine to form an up-facing first pocket for supporting plants and dirt, and that combine to form a down-facing shallow pocket. The plant stand further includes folding legs attached to the plant holder box that are movable between a raised position where the legs are located within the shallow pocket and a lowered use position where the legs support the holder box above a ground surface. The plant stand also includes a first detent arrangement for holding the legs in the raised position against the bottom of the holder box and a second detent arrangement for holding the legs in the lowered use position.

This application claims benefit under 35 USC 119(e) of provisional application Ser. No. 60/616,479, filed Oct. 6, 2004, entitled: PLANT STAND WITH FOLDING LEGS.

### BACKGROUND

The present invention relates to a multi-functional planter with the use of folding legs.

The market of selling planters is very competitive. Most planters in the market consist of molded plastic. Others are made from materials such as fiber, porcelain, clay, foam, and metal. All of the materials consist of many different patterns, textures, and designs. These planters are typically made into the same shapes such as pots, bowls and window boxes that are often low to the ground and only have one purpose or use.

Consumers prefer planters that can be flexibly used in different circumstances to create a desired aesthetic appearance. For example, a multi-purpose planter that can be raised and supported on legs, or transformed to be used as a planter box on a deck, deck rail, patio, porch etc. provides more options for the consumer. Furthermore, consumers having the ability to use the planter outside as well as inside is another advantage.

Another important aspect is that consumers want planters that are easily transformed from the initial configuration (shipping position) to the raised configuration (planter is raised with legs folded out). In a retail setting it is very important that the consumer can easily and quickly understand how to transform the planters. It is also important that this is done without requiring assembly and without accessory parts such as bolts, nuts, washers, etc.

One of the most important cost factors in this industry is transportation. It is critical that the planters can be tightly packed and condensed for transport as they may be imported from other countries. This is also important as it pertains to distribution. The planters may be directly shipped to horticultural growers so they can grow plants/flowers in the planters, then ship the product to retailers on tightly configured shipping racks. The planters may also be shipped to a distribution facility, packaged in a box, stored in a warehouse, then shipped to retailers or even directly to consumers through UPS or Fed Ex. It is desirable to provide a planter that minimizes all of these associated costs.

Another aspect concerns removable inserts for holding plants/flowers in planters. If the plants/flowers deteriorate and become poor in quality, the retailer wants the ability to dispose of the plants/flowers in the insert without discarding the planter itself. Further, retailers want to offer inserts tailored for each season to be used so that customers come back each season to purchase different inserts from the retailer after they have purchased the original planter.

Thus, a system having the aforementioned advantages and solving the aforementioned problems is desired.

### SUMMARY OF THE PRESENT INVENTION

In one aspect of the present invention, a plant stand includes a plant holder defining a box having side walls, end walls, and a bottom that combine to form an up-facing first pocket for supporting plants and dirt, and that combine to form a down-facing shallow pocket. The plant stand further includes folding legs attached to the plant holder that are movable between a raised position where the legs are located within the shallow pocket and a lowered position where the legs support the holder box above a ground surface.

In another aspect of the present invention, a planter adapted to support a plant includes a plant holder box having side walls, end walls, and a bottom that combine to form an up-facing first pocket for supporting plants and dirt, and that combine to form a down-facing shallow pocket, and folding legs attached to the basket for movement between a raised position and a downward use position. The plant stand includes a first detent arrangement for holding the legs in a raised position against a bottom of the holder box and a second detent arrangement for holding the legs in a downward use position.

These and other aspects, objects, and features of the present invention will be understood and appreciated by those skilled in the art upon studying the following specification, claims, and appended drawings.

### BRIEF DESCRIPTION OF DRAWINGS

FIGS. 1-5 are perspective, side, end, top, and bottom views of a plant stand embodying the present invention, the plant stand having its foldable legs in their extended use positions;

FIGS. 6-9 are similar to FIGS. 2-5, respectively, but with the legs folded to their recessed stored positions;

FIG. 10 is a perspective view of the bottom recess at one end of the plant stand, showing the detent structures and the U-shaped bracket for pivotally supporting the legs, but with the legs removed to better show the noted structure;

FIG. 11 is an enlarged perspective view similar to FIG. 10, but including the legs;

FIG. 12 is an elevational view of the leg and the detent structure for holding the legs in the extended use position and the U-shaped bracket for pivotally supporting the legs, the view being taken along the arrow XII in FIG. 2, but the bottom and side walls being removed to better show the pivot and detent structures; and

FIG. 13 is a side cross-sectional view taken along the plane XIII in FIG. 12.

FIGS. 14 and 15 are perspective views of an alternative plant stand with folding legs; the FIG. 14 including a pot for holding a plant, the FIG. 15 showing the plant stand empty;

FIG. 16 is a side view of FIG. 15, showing the legs in an extended use position;

FIGS. 17-19 are side views similar to FIG. 16, but FIG. 17 showing one leg moved partially toward its raised stored position, FIG. 18 showing the first leg in a stored position and a second leg moved partially toward its raised stored position, and FIG. 19 showing both legs in their respective raised stored positions;

FIG. 20 is a bottom view of FIG. 19; and

FIG. 21 is a perspective view of one leg set.

### DETAILED DESCRIPTION OF PREFERRED EMBODIMENTS

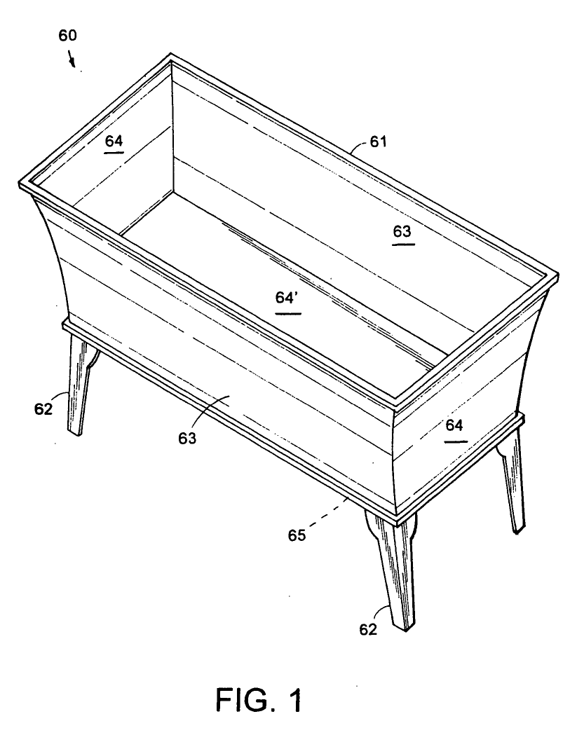

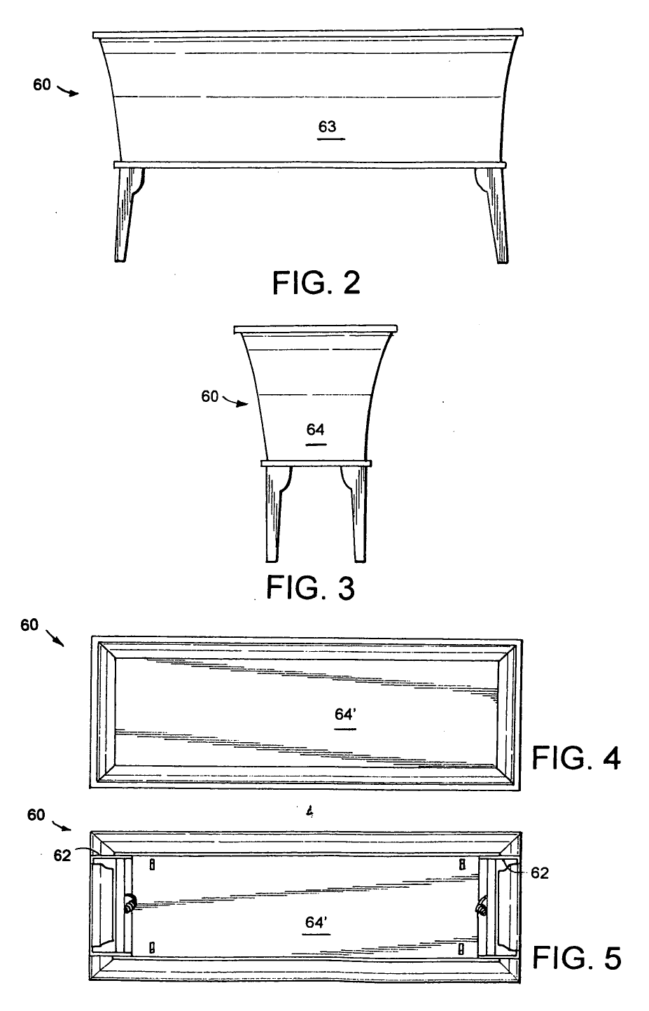

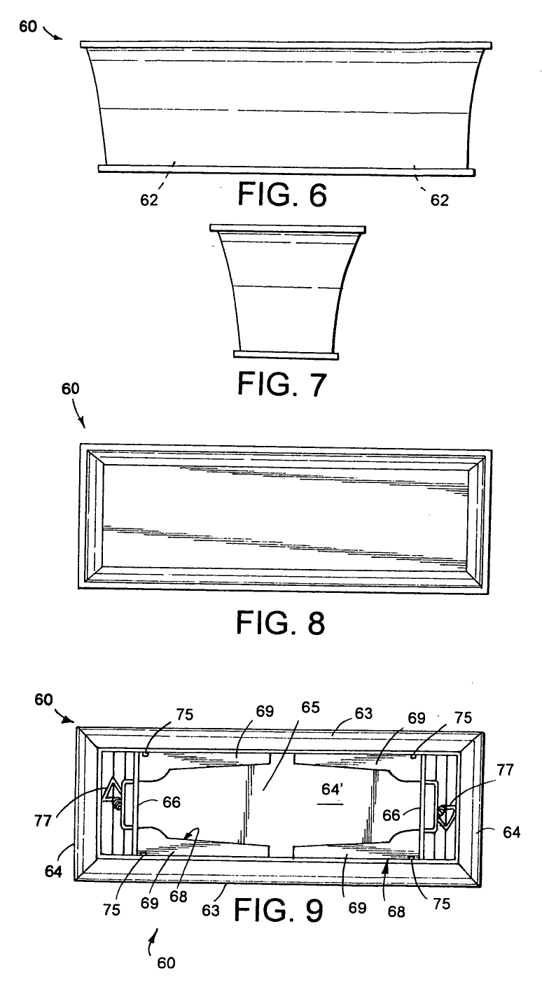

The planter stand 60 (FIG. 1) includes a rectangular box-shaped container 61 and leg members 62 that pivot between raised and lowered positions. When folded, the leg members 62 fit into a shallow recess in a bottom of the container 61, such that the containers can be nested for compact storage and shipment. When in the extended position, the leg members 62 are slightly angled outwardly for increased stability. The planter stand 60 further includes first and second detent arrangements for holding the leg members 62 in the raised and lowered positions, respectively.

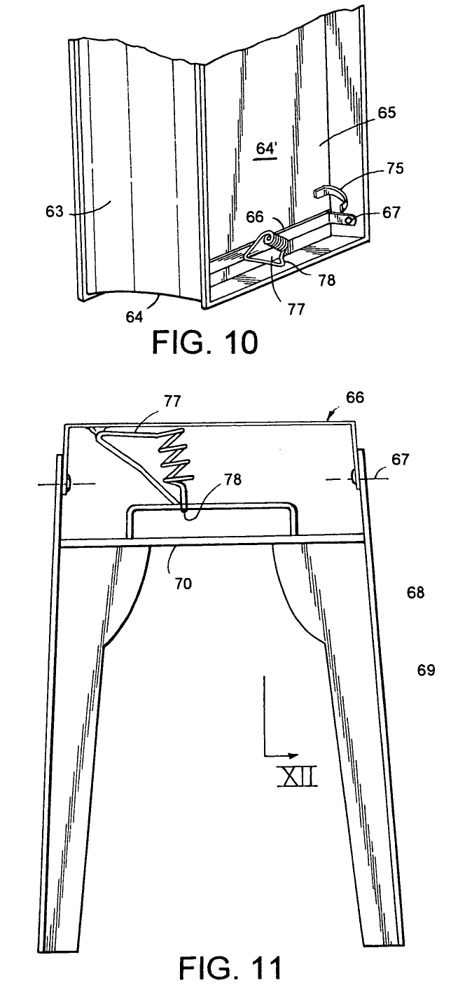

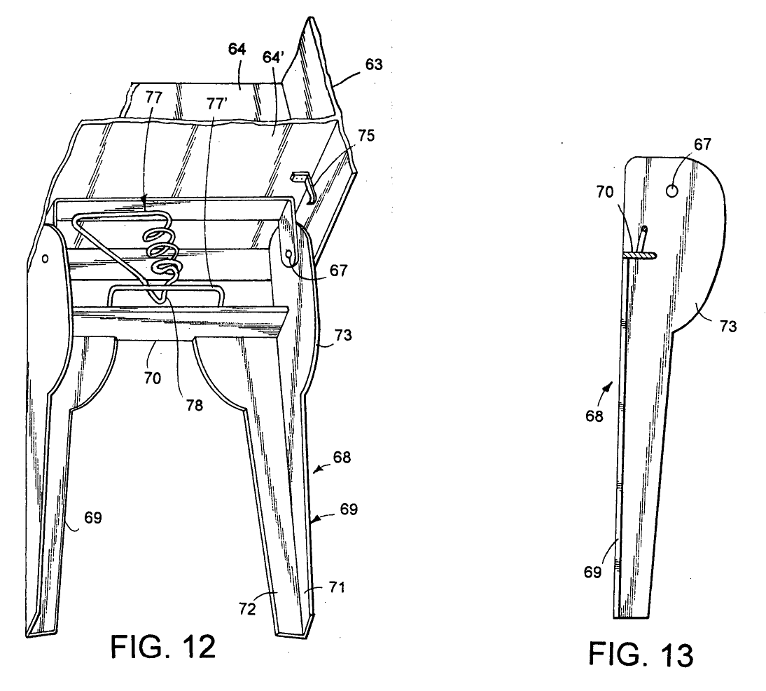

Specifically, the box-shaped container 61 (FIG. 1) includes side walls 63, end walls 64 and a bottom 64′ forming a large upwardly facing pocket for plants and dirt . . . and also forming a shallow downwardly facing pocket 65 (FIG. 10). The pocket 65 includes a U-shaped first bracket 66 at each end with tabs forming a pivot axis 67. The leg members 68 (FIG. 12) are U-shaped parts, and include two legs 69 connected by a cross brace 70. The leg members 68 are configured to be stamped from sheet metal. Each leg 69 includes a first flange 71 that extends parallel the associated side wall 63 and also includes a perpendicular second flange 72 that extends parallel the end wall 64, respectively. The side flange 71 includes an enlarged section 73 that moves adjacent and inside of the side wall 63. A friction tab 75 is attached to the bottom 64′ in the shallow pocket 65 and includes a resilient down tab shaped to frictionally engage the enlarged section 73, causing friction that holds the leg member 68 in the raised (stored) position within the shallow pocket 65. A bent-wire spring-type friction member 77 is also attached to the shallow pocket 65 and includes a resiliently supported retainer section 78. The cross bracket 70 on the leg member 68 includes a wire segment 77′ that engages the retainer section 78 when the leg member 68 is pivoted to its use position, holding the legs stably in their use position. Notably, the legs 68 are slightly angled outwardly when in the use position and are also supported by the side and end walls of the container 61 for increased stability.

It is contemplated that the planter can be designed to use either one of the friction tab (75) and the spring-type friction member (77) to hold the leg members 68 in the raised position. It is also contemplated that the planter can be designed to use either one of the friction tab (75) and the spring-type friction member (77) to hold the leg members 68 in the lowered (use) position. A person of ordinary skill in this art would understand this, and be able to construct the specifics of such an arrangement.

In the leg-folded condition, the planter stand 60 is particularly desirable because it can be nested for dense storage and shipment, and for display. This is very important because shipping costs are a large part of the planter business. Specifically, the planter stands 60 can be nested together, with each successive planter 60 taking up only an additional couple inches of vertical height. Further, the total height of the planter 60 when in the folded position is only about twelve inches high or less. Still further, the legs of the planter 60 can be folded while the planter 60 is holding a plant, without damaging the plant.

It is contemplated that plastic inserts will be made that fit matably into the top of the plant stand 60. The inserts will preferably be made of thin plastic material. If the plants/flowers deteriorate and become poor in quality, the retailer will have the ability to dispose of the plants/flowers in the insert without discarding the planter itself. The retailer will be able to offer inserts with different plants/flowers for each season to be used in the planter. This will also encourage customers to come back each season to purchase different inserts from the retailer after they have purchased the planter.

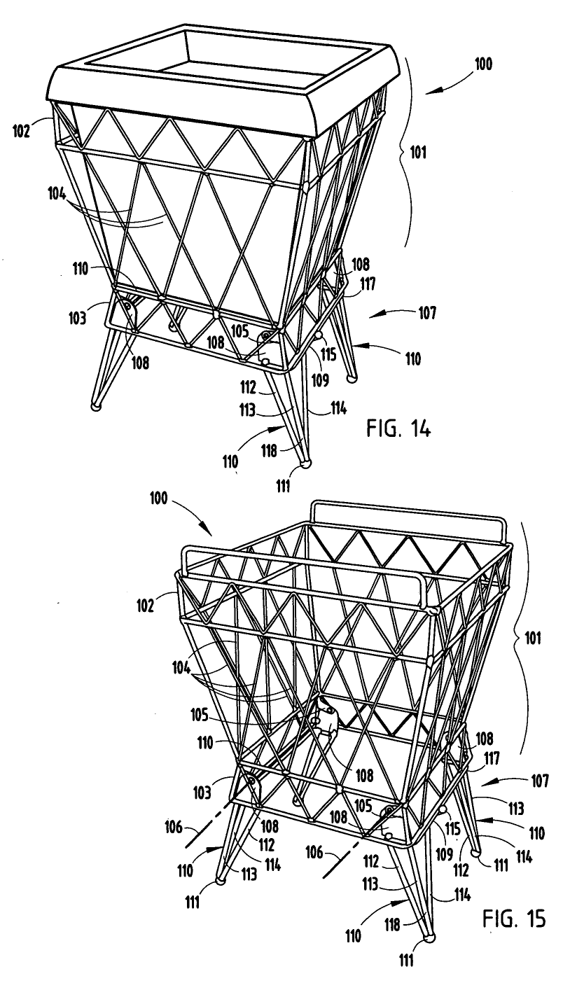

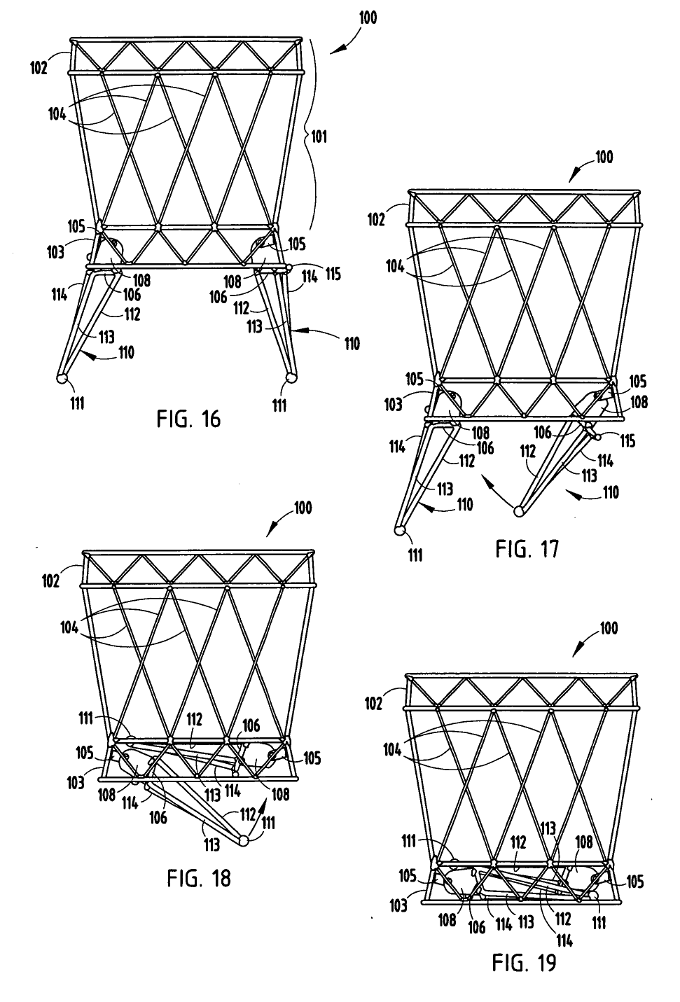

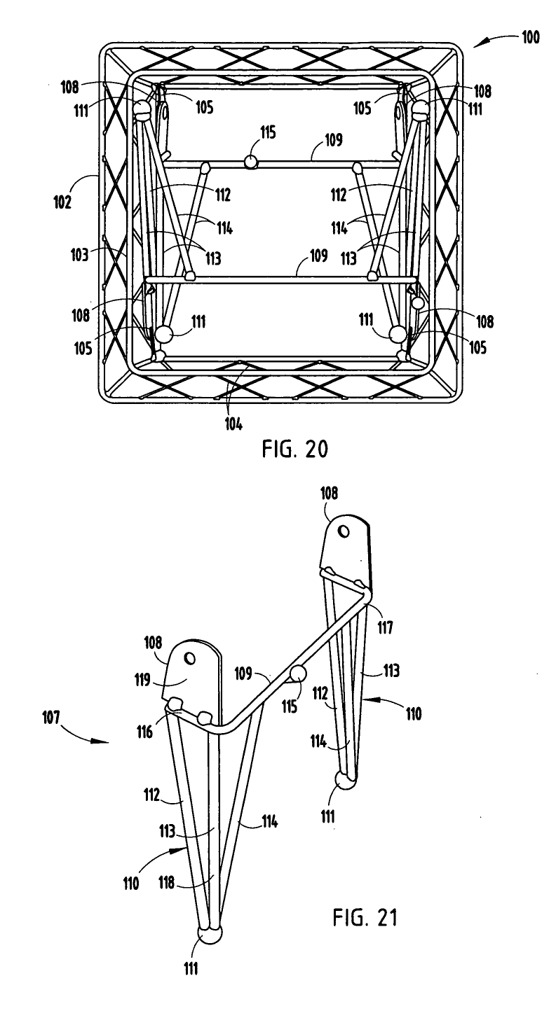

In an alternative design, a plant stand 100 (FIGS. 14-15) includes a plant holder 101 made of wire sections that form a top ring 102, a bottom ring 103, and vertically-extending members 104 that connect the top and bottom rings to form a box for receiving a plant-supporting plastic shell, with an exterior of the shell generally fitting within and matching a shape of the box. Where the vertically-extending members 104 are slightly angled inwardly to define an inverted pyramid shape, there is no need for horizontally extending members to extend across the bottom ring 103 . . . though it is contemplated that such cross members can be added if desired . . . and that the same is included within a scope of the present invention. Pivot-forming tabs 105 extend inwardly from corners of the bottom ring 103, and include holes near their outer end. The two holes on an adjacent pair of the tabs 105 align to form a pivot axis 106 for respective ones of the leg assemblies 107.

The leg assemblies 107 (FIG. 21) include tabs 108 supported by a transverse wire cross brace 109. Legs 110 are supported under each tab 108, each leg 110 including a foot 111 for engaging a floor surface. Each tab 108 is attached to the associated tab 105 by a pivot pin, such as a rivet. Each foot 111 includes two wire segments 112 and 113 that extend from spaced locations on tab 108 and by a third wire segment 114 that extends from a spaced location on wire cross brace 109. One or more detents are also attached to the leg assembly, such as the protrusion/detent 115 located at a mid location along the cross brace 109. Other detents can also be attached to the leg assembly for engagement with the bottom ring 103 as the leg assembly is pivoted to its raised stored position and also for engagement with the bottom ring 103 as the leg assembly is pivoted to its lowered use position, such as at any of locations 116-119 (FIG. 21).

Like plant stand 60, plant stand 100 is adapted so that the legs can be pivotally extended to a lowered use position. Also, the legs can be pivotally moved to a raised stored position where the legs are fully within a shallow recess formed under a bottom of the plant holder. This allows the plant stand to be positioned directly on a floor surface or flat surface without using the legs. It also allows the plant stand to be used in different ways . . . including sometimes as a legless stand, and also as a leg-supported stand (without the need to find and attach legs to the basic plant holder).

It is to be understood that variations and modifications can be made on the aforementioned structure without departing from the concepts of the present invention, and further it is to be understood that such concepts are intended to be covered by the following claims unless these claims by their language expressly state otherwise.

I claim:

1. A plant stand comprising:
a plant holder defining a box having side walls, end walls, and a bottom that combine to form an up-facing first pocket for supporting plants and dirt, and that combine to form a down-facing shallow pocket;
folding legs attached to the plant holder that are movable between a raised position where the legs are located within the shallow pocket and a lowered position where the legs support the holder box above a ground surface.

2. The plant stand defined in claim 1, wherein the plant holder is formed substantially from sheet metal.

3. The plant stand defined in claim 1, wherein the plant holder is formed substantially from wire segments.

4. The plant stand defined in claim 1, including a detent on one of the legs and plant holder that engages a mating part of the other of the legs and plant holder for retaining the legs in the raised position.

5. The plant stand defined in claim 4, wherein the detent also engages a second part of the other of the legs and plant holder for retaining the legs in the lowered position.

6. The plant stand defined in claim 5, wherein the detent is a protruding member adapted to move into snapping engagement.

7. The plant stand defined in claim 1, including a detent on one of the legs and plant holder that engages a mating part of the other of the legs and plant holder for retaining the legs in the lowered position.

8. The plant stand defined in claim 7, wherein the detent is a protruding member adapted to move into snapping engagement.

9. The plant stand defined in claim 1, including a detent on the legs for retaining the legs in the raised stored position and also in the lowered position.

10. The plant stand defined in claim 1, including first and second leg assemblies, each including two adjacent ones of the legs.

11. The plant stand defined in claim 10, wherein the first and second leg assemblies each include a cross brace connecting the adjacent legs.

12. The plant stand defined in claim 11, including a detent on the cross brace that snappingly engages the bottom when the legs are in the raised stored position.

13. The plant stand defined in claim 11, including a detent on the cross brace that snappingly engages the bottom when the legs are in the lowered position.

14. A planter adapted to support a plant, comprising:
a plant holder box having side walls, end walls, and a bottom that combine to form an up-facing first pocket for supporting plants and dirt, and that combine to form a down-facing shallow pocket;
folding legs attached to the basket for movement between a raised position and a downward use position;
a first detent arrangement for holding the legs in a raised position against a bottom of the holder box and a second detent arrangement for holding the legs in a downward use position.

15. The plant stand defined in claim 14, wherein the plant holder is formed substantially from wire segments.

16. The plant stand defined in claim 14, wherein the first detent arrangement includes a protruding member adapted to move into snapping engagement.

17. The plant stand defined in claim 14, wherein the second detent arrangement includes a protruding detent adapted to move into snapping engagement.
